(19) United States
(12) Patent Application Publication
(10) Pub. No.: US 2019/0044178 A1
(43) Pub. Date: Feb. 7, 2019

(54) THERMALLY STABLE BATTERY SEPARATOR DESIGNS

(71) Applicant: Apple Inc., Cupertino, CA (US)

(72) Inventors: Mikyong Yoo, Palo Alto, CA (US); Richard M. Mank, Los Altos, CA (US)

(73) Assignee: Apple Inc., Cupertino, CA (US)

(21) Appl. No.: 16/039,048

(22) Filed: Jul. 18, 2018

Related U.S. Application Data
(60) Provisional application No. 62/541,867, filed on Aug. 7, 2017.

(51) Int. Cl. H01M 10/04; H01M 4/62; H01M 10/0565

(52) U.S. Cl. CPC H01M 10/0459; H01M 10/0565; H01M 4/622

(57) ABSTRACT

Energy storage devices, battery cells, and batteries may include a cathode including a cathode current collector having a cathode active material disposed thereon. The devices may include an anode including an anode current collector having an anode active material disposed thereon. The devices may also include a separator positioned between the cathode active material and the anode active material. The separator may include a polymeric base, an intermediate layer, and an adhesive layer.

### CROSS-REFERENCE TO RELATED APPLICATIONS

This application claims priority to U.S. Provisional Application No. 62/541,867, filed Aug. 7, 2017, the disclosure of which is hereby incorporated by reference in its entirety for all purposes.

### TECHNICAL FIELD

The present technology relates to batteries and battery components. More specifically, the present technology relates to improved battery separator designs and configurations for energy storage devices.

### BACKGROUND

In rechargeable battery designs, the separator allows ionic transmission for charging and discharging, while preventing electrical contact between the electrode materials. As battery designs utilize different materials, and continue to increase in volumetric density, the separator may be stressed further during cycling.

### SUMMARY

Energy storage devices of the present technology, such as battery cells and batteries, may include a cathode including a cathode current collector having a cathode active material disposed thereon. The devices also include an anode including an anode current collector having an anode active material disposed thereon. The devices may also include a separator positioned between the cathode active material and the anode active material. The separator can have a polymeric base, an intermediate layer, and an adhesive layer.

In exemplary devices, the intermediate layer includes a ceramic material incorporated within a binder. The binder may be characterized by a glass transition temperature above about 100° C. The binder may include one or more of a polyimide, a polyamide, a polyamide imide, or an aramid. The ceramic material may be greater than or about 50 wt. % of the intermediate layer. The ceramic material may be or include a compound including an element selected from the group consisting of aluminum, boron, magnesium, silicon, titanium, yttrium, and zirconium. The adhesive layer may be or include an acrylate or polyvinylidene fluoride (“PVDF”). The adhesive layer may be disposed on the intermediate layer in a discontinuous coating.

The present technology also encompasses battery separators, which may include a polymeric material having a first surface and a second surface opposite the first surface. The separators may include a first intermediate layer and a second intermediate layer. Each intermediate layer may include a ceramic admixed with a binder. The first intermediate layer may be positioned adjacent the first surface of the polymeric base along a first surface of the intermediate layer. The second intermediate layer may be positioned adjacent the second surface of the polymeric base along a first surface of the intermediate layer. The separators may also include an adhesive disposed on each of the first intermediate layer and the second intermediate layer. The adhesive may be disposed on a second surface of the intermediate layers opposite the first surfaces of the intermediate layers.

In some embodiments, the polymeric base may be or include a polymeric hydrocarbon. The binder may be or include one or more of a polyimide, a polyamide, a polyamide imide, or an aramid. The binder may be less than or about 30 wt. % of the intermediate layer. The battery separator may be characterized by an air permeability of less than 300 seconds/100 cc. The battery separator may be characterized by a porosity of between about 35% and about 65%. The battery separator may be characterized by a thermal shrinkage of less than or about 30% at a temperature of about 150° C.

The present technology also encompasses energy storage devices. The devices may include a cathode including a cathode current collector having a cathode active material disposed thereon. The devices may include an anode including an anode current collector having an anode active material disposed thereon. The devices may also include a separator positioned between the cathode active material and the anode active material. The separator may include a polymeric base, intermediate layers coupled with each of two opposing sides of the polymeric base, and adhesive layers coupling the intermediate layers with each of the cathode active material and the anode active material. The intermediate layers may include a ceramic incorporated within a binder.

In some embodiments, the binder may be characterized by a glass transition temperature above about 150° C. The binder may be or include one or more of a polyimide, a polyamide, a polyamide imide, or an aramid. The adhesive layers may include a first adhesive in contact with the anode active material and a second adhesive in contact with the cathode active material. The first adhesive and the second adhesive may be or include different adhesives. The adhesive layers may include an acrylate or polyvinylidene fluoride (“PVDF”) in some embodiments.

The present technology may provide numerous benefits over conventional technology. For example, the present separators may have improved thermal stability during cycling operations. Additionally, the separators may have sufficient pore characteristics compared to conventional designs. These and other embodiments, along with many of their advantages and features, are described in more detail in conjunction with the below description and accompanying figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic view of layers of an energy storage device according to embodiments of the present technology.

FIG. 2 shows a schematic view of an exemplary separator according to embodiments of the present technology.

FIG. 3 shows a schematic view of an adhesive coating for an exemplary separator according to embodiments of the present technology.

FIG. 4 shows a schematic view of layers of an energy storage device according to embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Battery separators provide a variety of functions within a battery cell. In addition to supporting ionic transport between a cathode and anode, the material limits electrical contact of the two components to prevent electrical shorting between cathode and anode materials. Battery separators may be formulated by balancing a number of characteristics of the component. For example, battery separators may include materials selected based on compatibility with electrode materials or electrolyte materials, electrochemical stability, thermal stability, flexibility, and other factors. Battery separators can include combinations of components as well. For example, woven polymeric separators are sometimes utilized in battery designs because of the porosity provided. An issue with woven polymeric separators, however, is that they may be less thermally stable, and may shrink during operation or during abuse conditions causing increased temperatures. More thermally stable designs may include non-woven polymers and/or ceramic separators. However, these designs may lose mechanical flexibility and have reduced permeability, and may require increased thicknesses due to manufacturing limitations. For example, ceramic separators having a thickness less than a few dozen micrometers may exhibit a brittle structure reducing handling capability.

Conventional technologies have attempted to incorporate combinations of materials by combining polymers and ceramics. The ceramics may be included as a coating on a polymeric base, and the coating may include ceramics and binders suitable for coupling with electrode active materials. However, binders used in these processes may be selected based on a low glass transition temperature, which may aid coupling with the electrodes. For example, polyvinylidene fluoride (“PVDF”) may have adequate adhesion characteristics, but with a glass transition temperature below 0° C., the material exhibits thermal shrinking at higher temperatures experienced during battery manufacturing. These technologies may avoid materials with higher glass transition temperatures because the adhesion to electrode materials may be reduced causing gaps between electrodes and separators within the cell structure. Separators are often formed with an amount of overhang past the electrode portions of a battery cell, although at high temperature this additional material may be insufficient to account for thermal shrinkage of the separator materials. Should the separator shrink excessively, the anode and cathode materials may contact, causing a short within the battery cell.

In some embodiments, the present technology utilizes binders characterized by a higher glass transition temperature and incorporating an additional adhesive layer on the separator. Conventional technologies may not utilize an additional adhesive as it may block pores and increase air permeability of the separator, reducing its function. The present technology coordinates the adhesive with other layers of the separator design. Accordingly, the present technology provides separators characterized by improved thermal stability and other operational characteristics compared to conventional designs.

Although the remaining portions of the description will routinely reference lithium-ion batteries, it will be readily understood by the skilled artisan that the technology is not so limited. The present designs may be employed with any number of battery or energy storage devices, including other rechargeable and primary, or non-rechargeable, battery types, as well as electrochemical capacitors also known as supercapacitors or ultracapacitors. Moreover, the present technology may be applicable to batteries and energy storage devices used in any number of technologies that may include, without limitation, phones and mobile devices, handheld electronic devices, laptops and other computers, appliances, heavy machinery, transportation equipment including automobiles, water-faring vessels, air travel equipment, and space travel equipment, as well as any other device that may use batteries or benefit from the discussed designs. Accordingly, the disclosure and claims are not to be considered limited to any particular example discussed, but can be utilized broadly with any number of devices that may exhibit some or all of the electrical or chemical characteristics of the discussed examples.

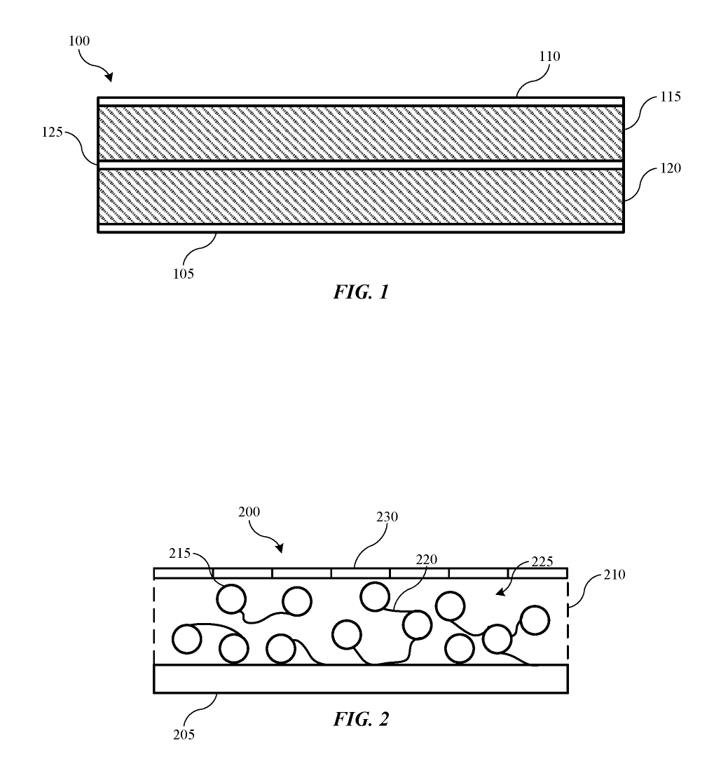

FIG. 1 shows a cross-sectional view of an exemplary energy storage device 100 according to some embodiments of the present technology. Energy storage device 100 is a battery, a battery cell, or some other energy storage device in embodiments. Exemplary energy storage device 100 includes a first current collector 105 and a second current collector 110, one of which may be the anode, and the other the cathode side of the energy storage device. Current collectors 105 and 110 may be made of any known collector materials, such as aluminum, copper, nickel, stainless steel, or a variety of other materials that may be capable of operating at cathode and anode potentials within the cell environment.

Energy storage device 100 includes electrode active material 115 disposed on current collector 110, and electrode active material 120 disposed on current collector 105. Again, either of electrode active materials 115, 120 may be the anode or cathode materials in exemplary designs. In some examples, electrode active material 115 is an anode material and includes a carbon-containing compound such as graphite or a lithium-containing compound such as lithium titanate. Any other anode materials may similarly be used with the present technology. Additionally, for example, electrode active material 120 is a cathode material including a lithium-containing material such as lithium cobalt oxide or lithium phosphate, among other known lithium compounds used in such devices. The electrode active material 120 may also include nickel, manganese, cobalt, aluminum, and a variety of other materials that would be understood to be encompassed by the present technology. Indeed, any possible anode and cathode materials that may be utilized in batteries including separators as will be described below are suitable for the present designs, and will be understood to be encompassed by the present technology. Separator 125 is disposed between the electrode active materials 115, 120, and may include a variety of materials that allows lithium ions to pass through the separator structure while not otherwise conducting electricity.

FIG. 2 shows a schematic view of an exemplary separator 200 according to embodiments of the present technology. Separator 200 may be included in a battery cell, such as battery cell 100 previously described. The separator may be positioned between active materials for an anode and a cathode in embodiments. Exemplary separator 200 is characterized by a polymeric base material 205, an intermediate layer 210, and an adhesive layer 230.

Base material 205 may include a number of materials including woven and non-woven materials. In some embodiments, base material 205 is a polymer formed by a wet or dry process. In some examples, the polymer is a polymeric hydrocarbon, which may include substituted hydrocarbons or functionalized polymers. In some examples, the polymer is a polyolefin, and may be or include polymers such as polyethylene, polypropylene, and other hydrocarbon-based polymers. The materials may include combinations of materials, such as polyethylene-polypropylene. Suitable materials may also include functional moieties including esters, aromatics, acetals, and other known functional groups. The materials may include thermoplastic materials, including polyethylene terephthalate or polyoxymethylene, and the materials may also include grafted polymers including polyethylenes with grafted materials such as siloxanes or methacrylates. In some embodiments, the base material is characterized by a melting point temperature providing shutdown of the separator in embodiments. For example, during abuse conditions, such as an event causing a short that increases internal temperatures of the battery cell, the base material at least partially melts. In this way, pores providing access across the separator melt, thereby halting or limiting any further discharging capability of the battery cell.

In some embodiments, intermediate layer 210 includes one or more materials including a ceramic material. Incorporating a ceramic material into the separator structure may afford dimensional stability as well as reduced thermal shrinkage. When incorporated as a particulate material, ceramics may include a platelet structure, which may increase tortuosity through the separator structure, or reduce porosity. Both pore size and pore structure relate to the ease with which ions, such as lithium ions, for example, may pass through the separator structure. The more tortuous the path through the structure, the more cycling rate capability may be reduced. Accordingly, intermediate layer 210 is not completely composed of ceramic materials in some embodiments.

In some embodiments, a binder is included in the intermediate layer with the ceramic materials, which provides a structure that maintains particular ion throughput characteristics for the separator. As illustrated within an unspecified spacing 225, binder material 220 may form polymer chains among ceramic particles 215. The ceramic particles 215 and the binder 220 are the materials composing the intermediate layer in some embodiments, while in some embodiments additional materials may also be included in the intermediate layer 210. When the ceramic particles and binder substantially make up the intermediate layer, the ceramic particles may be included at greater than or about 40 wt. % of the intermediate layer, and in embodiments the ceramic particles may be included at greater than or about 50 wt. %, greater than or about 60 wt. %, greater than or about 70 wt. %, greater than or about 80 wt. %, greater than or about 90 wt. %, greater than or about 95 wt. %, or more of the intermediate layer, with the balance being the binder material and/or additional components of the intermediate layer when included.

For example, in embodiments the binder is included at less than or about 60 wt. % of the intermediate layer. In some embodiments, the binder may be included at less than or about 50 wt. %, less than or about 40 wt. %, less than or about 30 wt. %, less than or about 20 wt. %, less than or about 10 wt. %, or less of the intermediate layer, with the balance being the ceramic particles, and/or any additional components that may be included in the intermediate layer.

Binders utilized with the present technology may be characterized by a glass transition temperature above operational temperatures of the battery cell. By utilizing binders having a higher glass transition temperature, separators according to the present technology are characterized by improved thermal and dimensional stability in embodiments, and are less prone to shrinking over cell lifetime or during abuse conditions, or may shrink to a lesser degree than separators including binders characterized by a lower glass transition temperature. In some embodiments, one or more including all binders utilized in the intermediate layer may be characterized by a glass transition temperature greater than or about 100° C. Additionally, binders used in the intermediate layer may be characterized by a glass transition temperature greater than or about 150° C., greater than or about 160° C., greater than or about 170° C., greater than or about 180° C., greater than or about 190° C., greater than or about 200° C., greater than or about 210° C., greater than or about 220° C., greater than or about 230° C., greater than or about 240° C., greater than or about 250° C., greater than or about 260° C., greater than or about 270° C., greater than or about 280° C., greater than or about 290° C., greater than or about 300° C., greater than or about 310° C., greater than or about 320° C., greater than or about 330° C., greater than or about 340° C., or greater.

Combinations of materials, amounts of materials, and characteristics of the materials themselves may produce binders characterized by a glass transition temperature of any temperature within any of the ranges described, or within smaller ranges, such as between about 190° C. and about 300° C. or less, in some embodiments. By utilizing binders characterized by higher glass transition temperatures, produced intermediate layers may be characterized by reduced flexibility or ductility compared to layers produced with other binders. However, the amount and types of binders may be modified, functionalized, or adjusted to limit cracking or other issues related to malleability, while still maintaining the desired thermal and dimensional stability characteristics.

A variety of materials may be used as binders according to the present technology. Binders may include any polymeric materials that may be characterized by any of the previously noted glass transition temperatures, compatibility with the ceramic particles, or chemical or electrochemical stability with electrolyte materials that may be used within battery cells. Exemplary materials that may be used or included with binders of the present technology may include polyimides. The polyimides may be linear or include aromatic moieties, and may include semi-aromatic polyimides. Exemplary polyimides may also be modified to incorporate additional functional moieties including carboxylate moieties, for example. The binder materials may also include polyamides, which may also be aliphatic, semi-aromatic, or otherwise include aromatic moieties such as aramids. Exemplary materials may include amorphous polymers, such as polyamide imides, for example, or other polymeric materials that are characterized by glass transition temperatures as discussed above, and exhibit other properties suitable for battery cells according to the present technology.

Ceramic materials that may be incorporated with the binders for the intermediate layer 210 may include any ceramic that may afford additional dimensional stability to the separator design. The ceramic materials may include oxides, nitrides, carbides, hydroxides, and titanates of a number of materials. Exemplary elements for these compounds may be or include barium, strontium, boron, iron, lead, zirconium, magnesium, silicon, aluminum, titanium, yttrium, or zinc. For example, exemplary ceramic materials may include aluminum nitride, aluminum oxide, including alpha and gamma classes, boron nitride, including hexagonal crystalline form, magnesium hydroxide, silicon nitride, silicon aluminum oxynitride or Sialon, as well as any other ceramic materials or combination.

Exemplary adhesive layer 230 is included along the intermediate layer 210 opposite the polymeric base layer 205. Binders utilized in separators according to the present technology may provide reduced adhesion to electrode active materials utilized in the cell. During cell cycling, as the active materials may swell, interfacial issues may extend without adequate adhesion between the separator and the electrode. This may allow further swelling, which may affect capacity or other capabilities of the battery cell. By incorporating an additional adhesive material, such as adhesive layer 230, the present technology may overcome issues related to binders characterized by improved thermal stability.

Exemplary adhesives may include a variety of adhesive materials that may couple or bond with both the intermediate layer 210 of the separator as well as an adjacent electrode active material. Suitable adhesives may include multiple adhesive materials including polymeric materials. Exemplary polymeric materials include materials including acetate, acrylate, vinyl groups, styrene, or any other materials that may be utilized according to the present technology. For example, exemplary adhesives may include acrylate and/or polyvinylidene fluoride (“PVDF”), including poly(vinylidene fluoride-co-hexafluoropropylene), the morphology of which may be controlled to limit reductions in porosity. For example, the adhesives may be provided in ovular or spherical shaped segments, which allow additional spacing between adhesive particles.

Exemplary adhesive particles may be characterized by a diameter of less than or about one micrometer in embodiments, and may be characterized by a diameter of less than or about 900 nm, less than or about 800 nm, less than or about 700 nm, less than or about 600 nm, less than or about 500 nm, less than or about 400 nm, less than or about 300 nm, less than or about 200 nm, less than or about 100 nm, or less. Additionally, the adhesive may be applied so as to further limit the effect on porosity or air permeability.

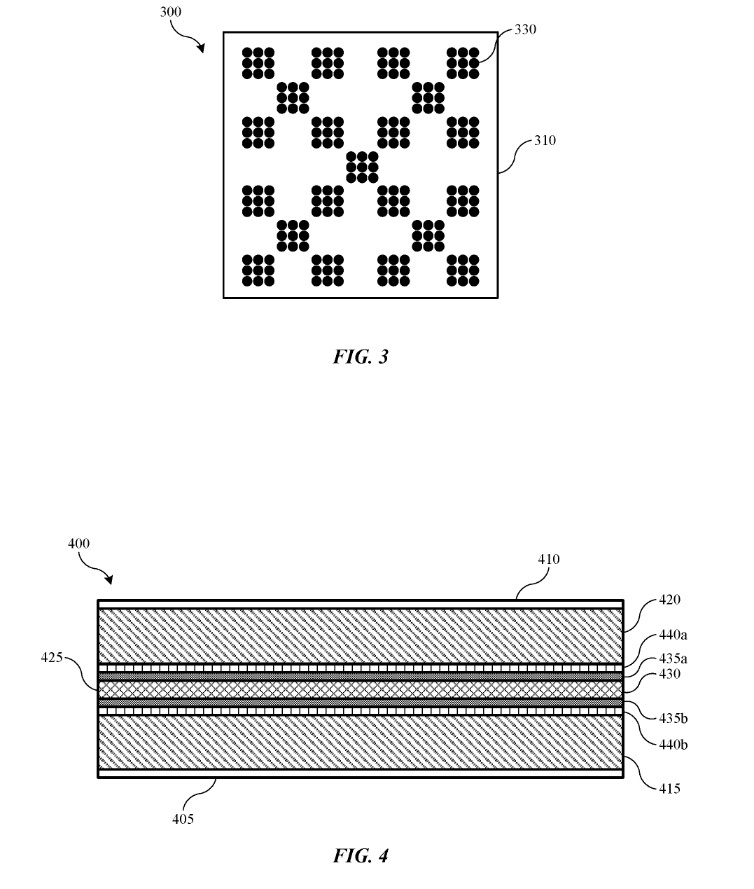

Turning to FIG. 3, a top view of an exemplary separator 300 according to embodiments of the present technology is shown. Separator 300 illustrates an exemplary pattern coating of adhesive particles 330 on an intermediate layer 310. Separator 300 and the constituent components illustrated may be any of the materials previously described. As illustrated, adhesive particles 330 may be staggered, or patch coated, along a surface of the separator. In embodiments, the adhesive layer is discontinuously coated along the surface of the separator in any number of ways. FIG. 3 is not intended to be limiting, and illustrates only one possible coating for explanation of the discontinuous coating. Additional coating may include lines or other shapes of adhesive particles formed across the surface of the separator.

When an additional adhesive is applied along a surface of the separator, the adhesive may block or otherwise affect the pores through the separator. This may affect air permeability, which may be related to rate capability of a battery cell in which the separator may be disposed. By utilizing any of a number of forms of discontinuous coating, the adhesive may be incorporated to reduce an impact on porosity and permeability, while providing sufficient adhesion to an electrode active material. Additionally, when the adhesive particles include a rounded, ovular, or spherical shape, gaps may be maintained about particles included in the adhesive layer.

Discontinuous coatings may be formed in any number of ways as noted above, such as with various coating techniques. Additionally, loading of the adhesive, or the amount of adhesive deposited, may be adjusted to create more of a patched distribution of adhesive, which may produce a non-uniform coating affording increased porosity and permeability. For example, lower loading of adhesive may be applied, such as in a sputtered application, to limit uniformity. The loading may be less than or about 10 g/m², and in some embodiments the loading may be less than or about 9 g/m², less than or about 8 g/m², less than or about 7 g/m², less than or about 6 g/m², less than or about 5 g/m², less than or about 4 g/m², less than or about 3 g/m², less than or about 2 g/m², less than or about 1 g/m², less than or about 0.9 g/m², less than or about 0.8 g/m², less than or about 0.7 g/m², less than or about 0.6 g/m², less than or about 0.5 g/m², less than or about 0.4 g/m², less than or about 0.3 g/m², less than or about 0.2 g/m², less than or about 0.1 g/m², or less.

By utilizing adhesives and coating as described, such as with loadings below or about 5 g/m², porosity and air permeability may be maintained to facilitate ionic transportation through exemplary battery cells. Exemplary separators according to the present technology may be characterized by a porosity greater than or about 15%, and may be characterized by a porosity greater than or about 20%, greater than or about 30%, greater than or about 40%, greater than or about 50%, greater than or about 60%, greater than or about 70%, greater than or about 80%, or more, although porosity may be maintained below or about 85%, below or about 80%, below or about 75%, below or about 70%, below or about 65%, or below or about 60%, to provide adequate control over transfer across the separator. Porosity may also be maintained within any range encompassed by any of these ranges or between any two noted or encompassed percentages.

As noted previously, air permeability may be related to porosity and pore tortuosity across a thickness of the separator, which may affect ionic transfer across the separator during operation in a battery cell. Air permeability may be measured as the time in seconds to pass 100 cubic centimeters of air across the separator. Separators according to the present technology may be characterized by air permeability across the separator of less than or about 400 s/100 cc. In some embodiments, the separator may be characterized by air permeability of less than or about 350 s/100 cc, less than or about 300 s/100 cc, less than or about 250 s/100 cc, less than or about 200 s/100 cc, less than or about 150 s/100 cc, less than or about 100 s/100 cc, less than or about 50 s/100 cc, or less. Any of the air permeability numbers may relate to any number of separator components or layers as well as any thickness of the separator or individual layers.

FIG. 4 illustrates a cross-sectional view of a battery cell 400 according to embodiments of the present technology. Battery cell 400 may include any of the components or characteristics previously discussed, and may include any of the separators or separator materials previously described. As illustrated, battery cell 400 includes a first current collector 405 and a second current collector 410. Either current collector may represent an anode current collector and the other a cathode current collector according to embodiments of the present technology. A first active material 415, e.g., a cathode active material, is coupled with the first current collector 405, e.g., a cathode current collector, and a second active material 420, e.g., an anode active material, is coupled with the second current collector 410, e.g., an anode current collector. A separator 425 may be disposed between the first active material 415 and the second active material 420.

Exemplary separator 425 includes a polymeric material 430, which is included as a central layer or core of the separator. Polymeric base 430 contacts a first surface of intermediate layers 435a and 435b on each of two opposing surfaces of the polymeric base 430. As illustrated, intermediate layer 435a may be positioned proximate a first surface of polymeric base 430, and intermediate layer 435b may be positioned proximate a second surface of polymeric base 430 opposite the first surface. Additionally, adhesive layers 440 may be disposed on second surfaces of intermediate layers 435, and the second surfaces may be opposite the first surfaces contacting the polymeric base. Adhesive layer 440a is positioned to couple a first surface of the separator with electrode active material 420, and adhesive layer 440b is positioned to couple a first surface of the separator with electrode active material 415. As previously explained, adhesive layer 440a and adhesive layer 440b may be included in a discontinuous coating across the second surfaces of intermediate layers 435 to limit the effect on pores and air permeability, as well as ionic transfer across the separator.

In some embodiments, the material composition of the electrode active material 415 and the material composition of the electrode active material 420 are different, based on use as a cathode or anode. These different materials may produce electrode active materials having different material properties, surface features, or other aspects that may relate to coupling with adhesive layers 440. In embodiments, adhesive layer 440a and adhesive layer 440b may be any of the materials previously described, and may be similar materials or the same adhesive material. In some embodiments, adhesive layer 440a is different from adhesive layer 440b, and one or both adhesive layers may be selected based on the composition of the electrode active material. Additionally, each adhesive layer may include a similar base or core polymer, but may include different functional groups, or may be modified based on the composition of the electrode material to which it may be coupled, and to promote or increase adhesion between the materials.

Separator 425 may be characterized by a thickness based on the materials included within each layer. For example, separator 425 may include a polymeric base material 430, two intermediate layers 435, and two adhesive layers 440, which may produce a thickness of separator 425. In embodiments, separator 425 may be characterized by a thickness less than or about 20 μm including all layers within the separator. Additionally, separator 425 may be characterized by a thickness less than or about 19 μm, less than or about 18 μm, less than or about 17 μm, less than or about 16 μm, less than or about 15 μm, less than or about 14 μm, less than or about 13 μm, less than or about 12 μm, less than or about 11 μm, less than or about 10 μm, less than or about 9 μm, less than or about 8 μm, less than or about 7 μm, less than or about 6 μm, less than or about 5 μm, or less. By forming separators of reduced dimensions, such as below about 15 μm or below or about 10 μm, additional space within any particular form factor may be utilized for additional electrode active material, which may increase the capacity of battery cells utilizing the present technology.

Separators according to the present technology may have improved thermal stability over conventional materials, and may be less prone to shrinking at high temperatures. Temperatures may increase both during manufacturing operations, such as lamination, as well as during operation of the produced battery cells. Additionally, during fault events, battery cells may be exposed to temperatures above or about 100° C., above 150° C., above 200° C., above 300° C., or higher. While many polymeric materials and binders as previously described may exhibit high dimensional reduction in one or more directions, the present technology may limit the amount of thermal shrinkage that occurs.

For example, separators according to the present technology may be characterized by a percentage shrink in one or both of the machine direction or transverse direction of less than 5% at temperatures of approximately 100° C. over a specific time period of about an hour, and may be characterized by a percentage shrink of less than or about 4%, less than or about 3%, less than or about 2%, or less. At temperatures of approximately 130° C. over a specific time period of about an hour, exemplary separators may be characterized by a percentage shrink of less than or about 10%, and may be characterized by a percentage shrink of less than or about 9%, less than or about 8%, less than or about 7%, less than or about 6%, less than or about 5%, less than or about 4%, or less. At temperatures of approximately 150° C. over a specific time period of about an hour, exemplary separators may be characterized by a percentage shrink of less than or about 40%, less than or about 35%, less than or about 30%, less than or about 25%, less than or about 20%, less than or about 15%, less than or about 10%, or less in either or both of a machine direction or a transverse direction of the separator. This may be an improvement of a reduction in thermal shrink of greater than or about 10%, greater than or about 20%, greater than or about 30%, greater than or about 40%, greater than or about 50%, greater than or about 60%, or more compared to conventional technology. By utilizing materials and structures as explained throughout the present disclosure, separators may be produced that have enhanced thermal and dimensional stability over conventional separator structures.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. An energy storage device comprising:
a cathode including a cathode current collector having a cathode active material disposed thereon;
an anode including an anode current collector having an anode active material disposed thereon; and
a separator positioned between the cathode active material and the anode active material, wherein the separator comprises a polymeric base, an intermediate layer, and an adhesive layer.

2. The energy storage device of claim 1, wherein the intermediate layer comprises a ceramic material mixed with a binder.

3. The energy storage device of claim 2, wherein the binder is characterized by a glass transition temperature above about 100° C.

4. The energy storage device of claim 3, wherein the binder comprises one or more of a polyimide, a polyamide, a polyamide imide, or an aramid.

5. The energy storage device of claim 2, wherein the ceramic material is greater than or about 50 wt. % of the intermediate layer.

6. The energy storage device of claim 2, wherein the ceramic material comprises a compound including an element selected from the group consisting of aluminum, boron, magnesium, silicon, titanium, yttrium, and zirconium.

7. The energy storage device of claim 1, wherein the adhesive layer comprises an acrylate or polyvinylidene fluoride (“PVDF”).

8. The energy storage device of claim 1, wherein the adhesive layer is disposed on the intermediate layer in a discontinuous coating.

9. The energy storage device of claim 8, wherein the adhesive layer is disposed on the intermediate layer at a loading of less than or about 5 g/m².

10. A battery separator comprising:
a polymeric base having a first surface and a second surface opposite the first surface;
a first intermediate layer and a second intermediate layer, wherein each intermediate layer includes a ceramic admixed with a binder, wherein the first intermediate layer abuts the first surface of the polymeric base along a first surface of the first intermediate layer, and wherein the second intermediate layer abuts the second surface of the polymeric base along a first surface of the second intermediate layer; and
an adhesive disposed on each of the first intermediate layer and the second intermediate layer, wherein the adhesive is disposed on a second surface of the intermediate layers opposite the first surfaces of the intermediate layers.

11. The battery separator of claim 10, wherein the polymeric base comprises a polymeric hydrocarbon.

12. The battery separator of claim 10, wherein the binder comprises one or more of a polyimide, a polyamide, a polyamide imide, or an aramid.

13. The battery separator of claim 10, wherein the binder is less than or about 30 wt. % of the intermediate layer.

14. The battery separator of claim 10, wherein the battery separator is characterized by an air permeability of less than 300 seconds/100 cc.

15. The battery separator of claim 10, wherein the battery separator is characterized by a porosity of between about 35% and about 65%.

16. The battery separator of claim 10, wherein the battery separator is characterized by a thermal shrinkage of less than or about 30% at a temperature of about 150° C.

17. An energy storage device comprising:
a cathode including a cathode current collector having a cathode active material disposed thereon;
an anode including an anode current collector having an anode active material disposed thereon; and
a separator positioned between the cathode active material and the anode active material, wherein the separator comprises a polymeric base, intermediate layers coupled with each of two opposing sides of the polymeric base, and adhesive layers coupling the intermediate layers with each of the cathode active material and the anode active material, and wherein the intermediate layers include a ceramic incorporated within a binder.

18. The energy storage device of claim 17, wherein the binder is characterized by a glass transition temperature above about 150° C.

19. The energy storage device of claim 18, wherein the binder comprises one or more of a polyimide, a polyamide, a polyamide imide, or an aramid.

20. The energy storage device of claim 17, wherein the adhesive layers include a first adhesive in contact with the anode active material and a second adhesive in contact with the cathode active material, and wherein the first adhesive and the second adhesive comprise different adhesives.

21. The energy storage device of claim 17, wherein the adhesive layers comprise an acrylate or polyvinylidene fluoride (“PVDF”).
